(19) United States
(12) Patent Application Publication
(10) Pub. No.: US 2018/0275771 A1
(43) Pub. Date: Sep. 27, 2018

(54) ELECTRONIC DEVICE WITH APPLICATION MANAGEMENT AND SYSTEM AND METHOD FOR SELECTION OF APPLICATIONS IN DEVICE

(71) Applicants: Fu Tai Hua Industry (Shenzhen) Co., Ltd., Shenzhen (CN); HON HAI PRECISION INDUSTRY CO., LTD., New Taipei (TW)

(72) Inventors: JING-HUAN WANG, Shenzhen (CN); CHUN-HUI LI, Shenzhen (CN); WEN-JUN ZHONG, Shenzhen (CN)

(21) Appl. No.: 15/621,225

(22) Filed: Jun. 13, 2017

(30) Foreign Application Priority Data
Mar. 21, 2017 (CN) 201710169281.7

(51) Int. Cl. G06F 3/038; G06F 3/0487; G06F 3/0481; G06F 9/44

(52) U.S. Cl. CPC G06F 3/038; G06F 9/44; G06F 3/04817; G06F 3/0487

(57) ABSTRACT

A method for selecting and starting a software application in an electronic device comprises steps of sensing pressure applied on a press button and converting the pressure into voltage signal, each application in the device having been made to correspond to a certain range of pressures. An application corresponding to the pressure range is determined and the selected application is started after a timing unit has counted the lapse of a certain period of time. An application selecting system and electronic device containing same are also provided.

### FIELD

The subject matter herein generally relates to application management and a system and method for selecting an application.

### BACKGROUND

An electronic device, such as telephone or tablet computer, has more and more applications displayed on a user interface of the electronic device. If the user wants to open an application, the user needs to look for the application on the user interface, which is time consuming and inconvenient.

### BRIEF DESCRIPTION OF THE DRAWINGS

Many aspects of the present disclosure are better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the views.

FIG. 1 is a block diagram of an electronic device.

FIG. 2 is an applying diagram of the electronic device of FIG. 1.

FIG. 3 is a block diagram of an application selecting module of the electronic device of FIG. 1.

FIG. 4 is a block diagram of an application selecting system of the electronic device of FIG. 1.

FIG. 5 is a flowchart of an application selecting method for the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series, and the like.

The present disclosure is described in relation to an electronic device. The electronic device comprises a press button, an application storing module storing applications stored in the electronic device, and an application selecting module selecting and starting applications stored in the electronic device. Therein, the application selecting module comprises a pressure sensing unit, coupled to the press button, and configured to sense pressure applied on the press button and convert the pressure into voltage signal. The application selecting module comprises a storage unit, coupled to the application storing module, and storing a plurality of pressure ranges, wherein each pressure range is corresponded to one application of the application storing module. The application selecting module comprises a processing unit, coupled to the pressure sensing unit and the storage unit. The application selecting module comprises a controlling unit coupled to the application storing module, and configured to start any application of the application storing module. The application selecting module comprises a timing unit, coupled to the storage unit and the controlling unit. Wherein, the processing unit obtains sensing data from the voltage signal, and obtains pressure data from the sensing data; the processing unit determines which pressure range the pressure data is within, and selects the application corresponding to the pressure range, and further controls the timing unit to begin timing; and the processing unit starts the application corresponding to the pressure range when the timing unit has reached a predetermined value.

The present disclosure is described in relation to an application selecting method, for selecting and starting applications stored in an electronic device. Therein, the application selecting method comprises follow steps. Sense pressure applied on the press button and converting the pressure into voltage signal. Obtain sensing data from the voltage signal and obtains pressure data from the sensing data. Determine which pressure range the pressure data is within, and select an application corresponding to the pressure range; controlling the timing unit to begin timing. Starting the application which corresponds to the pressure range when the timing unit has reached a predetermined value.

The present disclosure is described in relation to an application selecting system, for selecting and starting applications stored in an electronic device. Therein, the application selecting system comprises at least one processing unit; and a non-transitory computer readable medium coupled to the at least one processing unit and configured to store instructions for execution by the at least one processing unit. The instructions cause the at least one processing unit to: obtain sensing data from voltage signal generated by a pressure sensing unit, and further obtain pressure data from the sensing data, determine which pressure range the pressure data is within, for selecting an application corresponding to the pressure range, and control a timing unit to begin timing, and further start the application corresponding to the pressure range when the timing unit has reached a predetermined value.

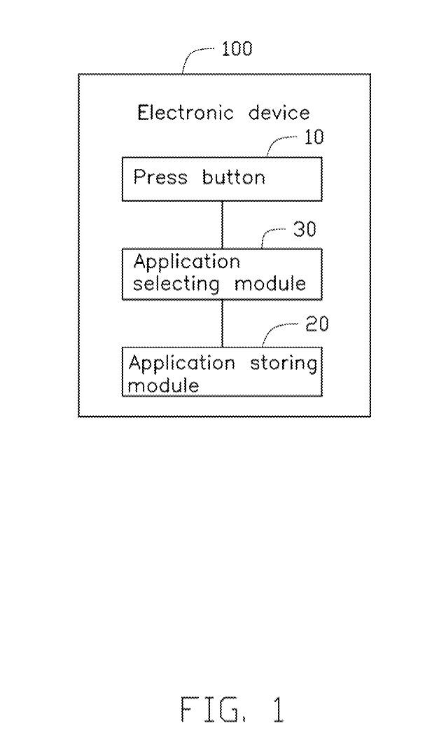

FIG. 1 shows an exemplary embodiment of an electronic device 100. The electronic device 100 can include a real or virtual press button 10 (see further discussion below), an application storing module 20, and an application selecting module 30. The application selecting module 30 can be coupled to the press button 10 and the application storing module 20. The application selecting module 30 can be configured to sense pressure applied on the press button 10 by a user. The application selecting module 30 can be further configured to select applications stored in the application storing module 20 and start the selected applications according to the sensed pressure. The electronic device 100 can be but is not limited to a telephone, a tablet computer, or the like. In this embodiment, the electronic device 100 can be a telephone. The application selecting module 30 can be configured to select applications stored in the device 100 and start the selected applications.

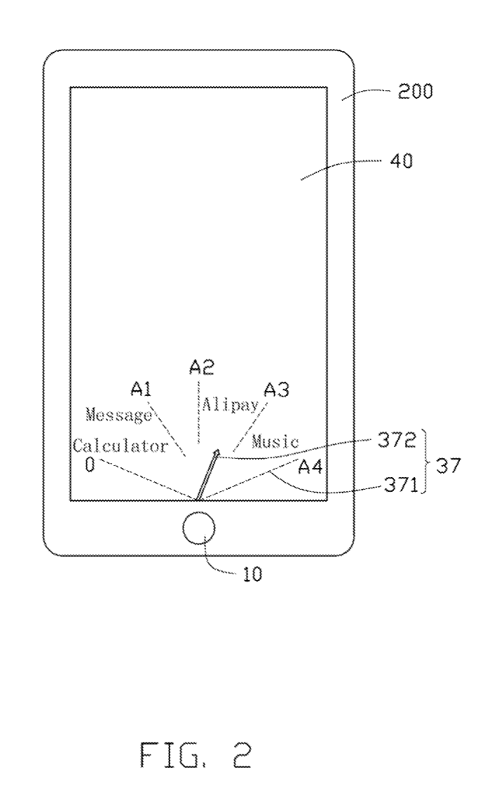

FIG. 2 shows that the press button 10 can be a virtual key or a mechanical key. In this embodiment, the press button 10 can be a mechanical key. The press button 10 can be adjacent to the display screen 40 of the electronic device 100. Preferably, the press button 10 can be a home button of the electronic device 100. The electronic device 100 can be operated by the user applying different pressures on the home button, such that different applications stored in the application storing module 20 can be selected and started.

The application storing module 20 can include a number of applications pre-stored in the electronic device 100, and further include a number of applications downloaded from the Internet and stored on the electronic device 100. As shown in FIG. 2, the application storing module 20 can include applications, such as Calculator, Message, Alipay, and the like.

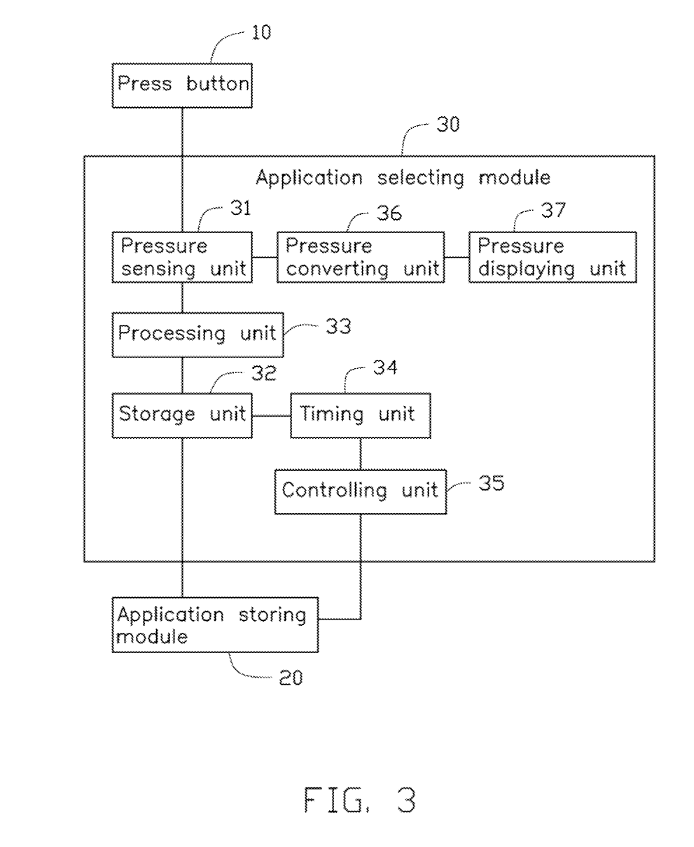

As shown in FIG. 3, the application selecting module 30 can include a pressure sensing unit 31, a storage unit 32, a processing unit 33, a timing unit 34, and a controlling unit 35. The pressure sensing unit 31 can be coupled to the press button 10. The pressure sensing unit 31 can be configured to sense pressure applied on the press button 10. The storage unit 32 can be coupled to the application storing module 20. The processing unit 33 can be coupled to the pressure sensing unit 31 and the storage unit 32. The timing unit 34 can be coupled to the storage unit 32 and the controlling unit 35. The controlling unit 35 can be coupled to the application storing module 20.

The pressure sensing unit 31 can be positioned below the press button 10. The pressure sensing unit 31 can be configured to sense the pressure applied on the press button 10, and further convert the amount of pressure into voltage signal.

Preferably, the application selecting module 30 can further include a pressure converting unit 36 and a pressure displaying unit 37. The pressure converting unit 36 can be configured to receive the voltage signal from the pressure sensing unit 31 and further convert the voltage signal into pressure data, and further transmit the pressure data to the pressure displaying unit 37. The pressure displaying unit 37 can be configured to instantly display on the device display screen 40 the pressure applied on the press button 10.

In detail, as shown in FIG. 2, the pressure displaying unit 37 can include a dial 371 and a pointer 372. In this embodiment, the dial 371 can be virtual dial, and the pointer 372 can be virtual pointer. The dial 371 and the pointer 372 can be displayed on the device display screen 40 of the electronic device 100. The pressure display area of the dial 371 can be divided into a number of pressure ranges, such as 0˜A1, A1˜A2, A2˜A3, A3˜A4, or the like. Each pressure range can correspond to an application stored in the application storing module 20. For example, range A2˜A3 can correspond to Alipay of the application storing module 20. The pointer 372 can appear when the voltage signal of the pressure converting unit 36 is received, and further indicate a pressure range so as to display the pressure which is applied to the press button 10.

As shown in FIG. 3, the storage unit 32 can be configured to store a number of pressure ranges, such as 0˜A1, A1˜A2, A2˜A3, A3˜A4 or the like. Each pressure range can correspond to one function of the application storing module 20. In at least one embodiment, the pressure ranges can be defined according to need. The relationship between the pressure ranges and the applications can be defined according to need. In at least one embodiment, the storage unit 32 can be an internal storage system, such as a flash memory, a random access memory (RAM) for temporary storage of information, and/or a read-memory (ROM) for permanent storage of information.

In at least one embodiment, the storage unit 32 can also be a storage system, such as a hard disk, a storage card, or a data storage medium. The storage unit 32 can include volatile and/or non-volatile storage devices.

In at least one embodiment, the storage unit 32 can include two or more storage devices such that one storage device is a memory and the other storage device is a hard drive. Additionally or alternatively, the storage unit 32 can be either entirely or partially external relative to the electronic device 100.

The processing unit 33 can be configured to obtain pressure data from the voltage signal generated by the pressure sensing unit 31. The processing unit 33 can be configured to determine the pressure range that the sensed pressure is within, and further control the timing unit 34 to begin timing when the sensed pressure is found to be within one pressure range. The processing unit 33 can be further configured to control the timing unit 34 to begin timing again when the pressure data is within another pressure range. In at least one embodiment, the processing unit 33 can be a central processing unit, a digital signal processor, or a single chip, for example.

The timing unit 34 can be configured to time a duration of the pressure being within one pressure range.

The controlling unit 35 can, when the time duration has reached a predetermined value, control the application storing module 20 to start the application corresponding to the certain pressure range.

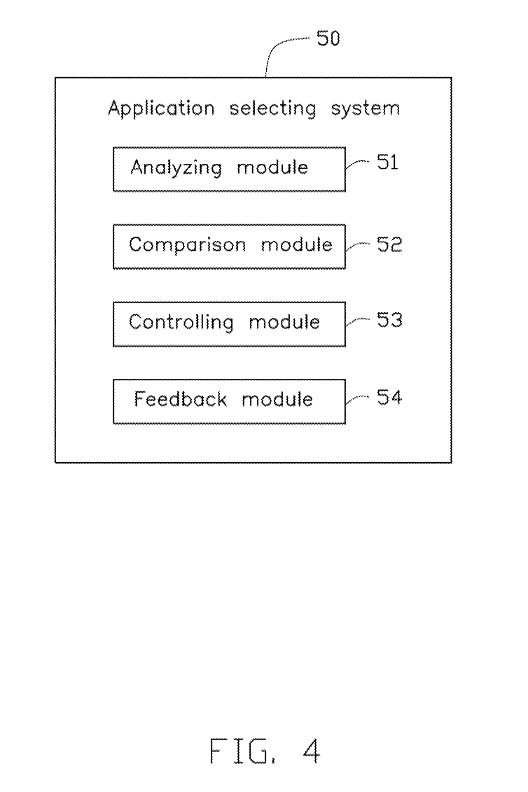

As shown in FIG. 4, the application selecting system 50 can be applied on the electronic device 100. The application selecting system 50 can include an analyzing module 51, a comparison module 52, a controlling module 53, and a feedback module 54. The analyzing module 51, comparison module 52, controlling module 53, and feedback module 54 can be stored in the storage unit 32 of the electronic device 100. The modules of the application selecting system 50 can include separated functionalities represented by hardware or integrated circuits, or as software and hardware combinations, such as a special-purpose processor or a general-purpose processor with special-purpose firmware.

The analyzing module 51 can be configured to obtain pressure data from the voltage signal generated by the pressure sensing unit 31.

The comparison module 52 can be configured to determine which pressure range the pressure data is within, for selecting the application corresponding to the application storing module 20.

The controlling module 53 can be configured to control the timing unit 34 to begin timing.

The feedback module 54 can be configured to determine whether the sensed pressure is still within the pressure range. When the feedback module 54 determines that the pressure is not within the pressure range, the feedback module 54 generates a feedback signal to the controlling module 53. The controlling module 53 can control the timing unit 34 to suspend timing when the feedback signal is received.

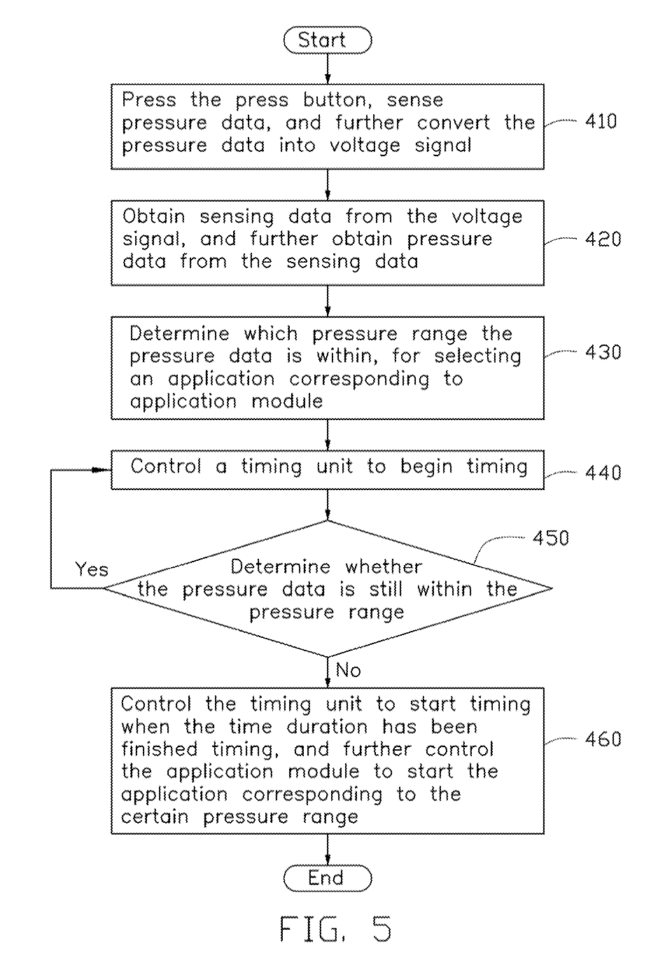

FIG. 5 illustrate a flowchart of an application selecting method. This application selecting method is merely an example, as there are a variety of ways to carry out the method. The application selecting method described below can be carried out using the configurations illustrated in FIG. 4, for example, and various elements of these figures are referenced in explaining the example method. Each block shown in FIG. 4 represents one or more processes, methods, or subroutines carried out in the example method. Furthermore, the illustrated order of blocks is by example only and the order of the blocks can be changed. Additional blocks may be added or fewer blocks may be utilized, without departing from this disclosure. The example method can begin at block 410.

At block 410, the user presses the press button 10, the pressure sensing unit 31 senses the pressure applied on the press button 10, and further convert the pressure into voltage signal.

At block 420, the analyzing module 51 obtains sensing data from the voltage signal generated by the pressure sensing unit 31, and further obtain pressure data applied on the press button 10 from the sensing data.

At block 430, the comparison module 52 determines which pressure range the pressure data is within, for selecting the application corresponding to the application storing module 20.

At block 440, the controlling module 53 controls the timing unit 34 to begin timing.

At block 450, the feedback module 54 determines whether the pressure data is still within the pressure range, if not, the process goes to block 440, otherwise, the process goes to block 460.

At block 460, the controlling unit 35 controls the timing unit 34 to begin timing when the time duration has reached a predetermined value, and further controls the application storing module 20 to start the application corresponding to the certain pressure range.

The embodiments shown and described above are only examples. Many details are often found in the art such as the features of electronic device with applications management and system and method for selection of applications in device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will, therefore, be appreciated that the embodiments described above may be modified within the scope of the claims.

What is claimed is:

1. An electronic device, comprising a press button, an application storing module storing applications stored in the electronic device, and an application selecting module selecting and starting applications stored in the electronic device, wherein, the application selecting module comprises:
a pressure sensing unit, coupled to the press button, and configured to sense pressure applied on the press button and convert the pressure into voltage signal;
a storage unit, coupled to the application storing module, and storing a plurality of pressure ranges, wherein each pressure range is corresponded to one application of the application storing module;
a processing unit, coupled to the pressure sensing unit and the storage unit;
a controlling unit coupled to the application storing module, and configured to start any application of the application storing module; and
a timing unit, coupled to the storage unit and the controlling unit;
wherein, the processing unit obtains sensing data from the voltage signal, and obtains pressure data from the sensing data; the processing unit determines which pressure range the pressure data is within, and selects the application corresponding to the pressure range, and further controls the timing unit to begin timing; and the processing unit starts the application corresponding to the pressure range when the timing unit has reached a predetermined value.

2. The electronic device of claim 1, wherein, the processing unit controls the timing unit to begin timing again when the pressure data is within another pressure range.

3. The electronic device of claim 1, wherein, the pressure sensing unit is positioned below the press button.

4. The electronic device of claim 1, wherein, the application selecting module further comprises a pressure converting unit and a pressure displaying unit; the pressure converting unit receives the voltage signal and converts the voltage signal into the pressure data; the pressure displaying unit displays the pressure data in time.

5. The electronic device of claim 4, wherein, the pressure displaying unit comprises a dial and a pointer, the dial and the pointer are displayed on the electronic device, the dial is divided into the plurality of pressure ranges, the pointer appears when the voltage signal of the pressure converting unit is received, and further indicates one corresponding pressure range.

6. The electronic device of claim 5, wherein, the dial is a virtual dial, and the pointer is a virtual pointer.

7. An application selecting method, for selecting and starting applications stored in an electronic device, wherein, the application selecting method comprises:
sensing pressure applied on the press button and converting the pressure into voltage signal;
obtaining sensing data from the voltage signal and obtains pressure data from the sensing data;
determining which pressure range the pressure data is within, and selecting an application corresponding to the pressure range;
controlling the timing unit to begin timing; and
starting the application which corresponds to the pressure range when the timing unit has reached a predetermined value.

8. The method of claim 7, wherein, the method comprises:
controlling the timing unit to begin timing again when the pressure data is within another pressure range.

9. The method of claim 7, wherein, the pressure sensing unit is positioned below the press button.

10. The method of claim 7, wherein, the method further comprises:
receiving the voltage signal and converting the voltage signal into the pressure data; and
displaying the pressure data in time.

11. An application selecting system, for selecting and starting applications stored in an electronic device, wherein, the application selecting system comprises:
at least one processing unit; and
a non-transitory computer readable medium coupled to the at least one processing unit and configured to store instructions for execution by the at least one processing unit, the instructions causing the at least one processing unit to:
obtain sensing data from voltage signal generated by a pressure sensing unit, and further obtain pressure data from the sensing data;
determine which pressure range the pressure data is within, for selecting an application corresponding to the pressure range; and
control a timing unit to begin timing, and further start the application corresponding to the pressure range when the timing unit has reached a predetermined value.

12. The system of claim 11, wherein, the instructions causing the at least one processing unit to:
determine whether the pressure data is still within the pressure range;
generate a feedback signal to the controlling module when the pressure data is not within the pressure range; and
control the timing unit to begin timing again when the feedback signal is received.

13. The system of claim 11, wherein, the pressure sensing unit is positioned below the press button.

14. The system of claim 11, wherein, the instructions causing the at least one processing unit to:
receive the voltage signal and convert the voltage signal into the pressure data; and
display the pressure data in time.
